(19) United States
(12) Patent Application Publication
(10) Pub. No.: US 2003/0147135 A1
(43) Pub. Date: Aug. 7, 2003

(54) Optical device

(76) Inventor: Bernd Ozygus, Berlin (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/343,671

(22) PCT Filed: Jul. 31, 2001
(86) PCT No.: PCT/EP01/08839

(30) Foreign Application Priority Data
Aug. 4, 2000 (DE) 10039341.1

(51) Int. Cl. G02B 21/00

(52) U.S. Cl. 359/431; 359/368; 359/385; 359/387

(57) ABSTRACT

The invention relates to an optical device comprising a stereomicroscope having a lens (4, 13), and a laser (5) which emits a laser beam (8) for machining a workpiece (9). The inventive device is characterised in that a tiltable mirror (10) is provided, by means of which the laser beam (8) can be guided through the lens (4, 13) over the workpiece (9).

The present invention relates to an optical device including a stereomicroscope having a lens and a laser which emits a laser beam for machining a workpiece.

Micromachining with solid-state laser systems is an already well-introduced technology which is finding wider and wider applications because of its physical advantages. Here, the field of application ranges from varied forms of machining in the metal field (welding, drilling, cutting, marking) to medicine and biology. Many special processing tasks can only be accomplished with lasers. Besides the small spot diameter of the laser beam on the workpiece or the sample, good visual control of the process is important for the processing result. A way to achieve this is to use a stereomicroscope in which the laser is coupled into the optical path of the stereomicroscope. In the designs currently in use, the laser beam is coupled into the beam path of the microscope via a fixed dichroic mirror which is simultaneously used by the monitoring beam path and the laser beam path. Focusing of the laser and monitoring are carried out via the same lens. In order to achieve a smaller spot diameter of the laser beam on the workpiece or the sample, the laser beam is widened in a suitable manner using a telescope. The monitoring of the processing operation is done via a magnification changer or a zoom optical system using the microscope eyepieces or a CCD camera.

The alignment of the laser beam with respect to workpiece as well as a selective processing are accomplished by moving the workpiece relative to the microscope. In this context, the position of the laser beam within the area observed through the microscope remains fixed. From a standpoint of work physiology, this type of monitoring is rather unfavorable because the image always moves as a whole during processing, as a result of which phenomena of fatigue are more likely to occur. German Published Patent Application No. 197 12 795 A1 discloses a device for uninterrupted manual laser processing using a fixed laser beam.

Therefore, the object of the present invention is to specify an optical device which features a stereomicroscope and allows a workpiece to be processed by a laser beam in a simple, ergonomic and precise manner and which, moreover, has a compact design.

The above objective is achieved by an optical device which features a tiltable mirror by means of which the laser beam can be guided through the lens over the workpiece.

The present invention advantageously allows the workpiece to be in a fixed position while the laser spot can be moved at the same time.

According to the present invention, no dichroic mirror but a tiltable deflection mirror is provided in the laser beam path. A further important advantage of this device is the much more compact design. A powered movement of the workpiece can be dispensed with. The translation elements used in known methods heretofore have a relatively large design (preloaded spindles, etc.) because of the high spatial resolution requirement.

In a preferred embodiment, the tiltable mirror is arranged inside the stereomicroscope. In another variant, the tiltable mirror is arranged between the laser and the stereomicroscope; it being preferred to provide a fixed deflection mirror which receives the laser beam coming from the tiltable mirror and deflects it to the lens.

A particularly preferred embodiment is one in which the tiltable mirror is motor-driven. Preferably, the tiltable mirror includes a piezoelectrically driven nutating table, provision being made for a control element which is used to adjust the angular position of the nutating table and is preferably designed as a joystick. A computer mouse, a track ball, or other input devices can also be used.

In a preferred embodiment of the optical device, the laser beam can be focused by the lens to a focus, the focus having a focus diameter. Also provided is a telescope with adjustable magnification which allows adjustment of the focus diameter and of the divergence of the laser beam. Through adjustment of the divergence, it is possible to influence the axial position of the focus in the workpiece.

The subject matter of the invention is schematically represented in the drawing and is described below with reference to the Figures, in which equally acting elements are denoted by the same reference numerals.

In this context,

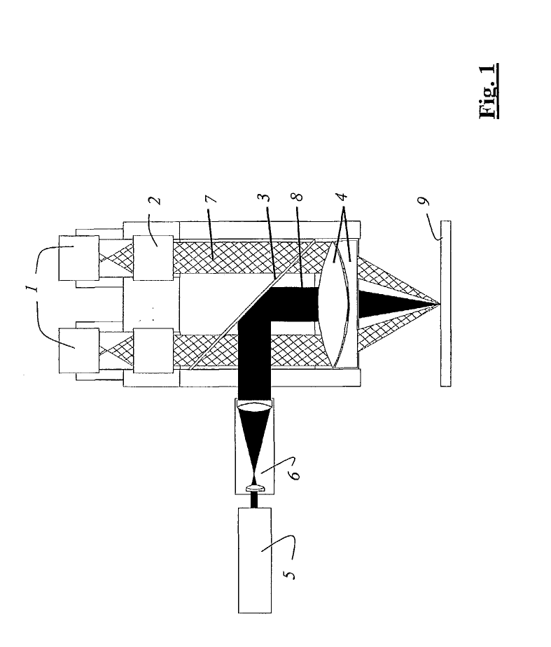

FIG. 1 shows an optical device according to the prior art; and

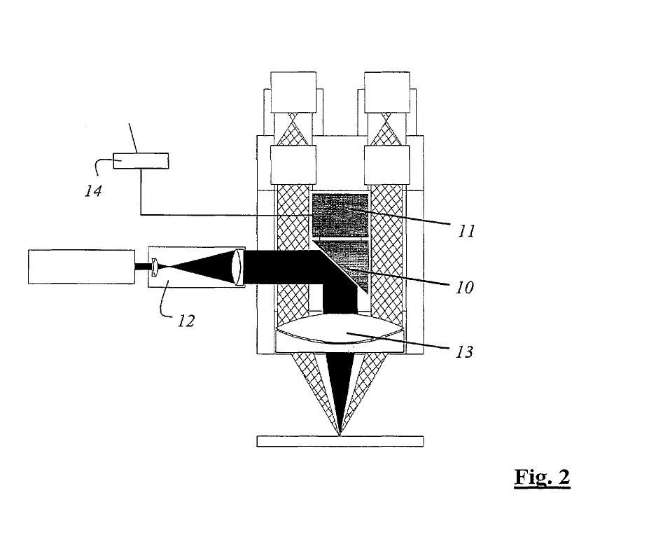

FIG. 2 shows an optical device according to the present invention.

FIG. 1 depicts an optical device according to the prior art. The laser beam is coupled into the optical path of the microscope via a fixed dichroic mirror 3 which is simultaneously used by monitoring beam 7 and laser beam 8. Focusing of the laser 5 and monitoring are carried out via the same lens 4. In order to achieve a smaller spot diameter of laser beam 8 on workpiece 9 or the sample, the laser beam is widened in a suitable manner using a telescope 6. The monitoring of the processing operation is done using a magnification changer or a zoom optical system 2 using the microscope eyepieces 1 or a CCD camera.

FIG. 2 shows a design in which the deflection is accomplished by a tiltable deflection mirror 10 which is designed as a piezoelectrically driven nutating table 11. Such components can be easily integrated into a stereomicroscope because of their compact external dimensions. For example, with an angular range of nutating table 11 of 4 mrad and a focal length of lens 13 of 50 mm, a scanning area of 200 m×200 m is obtained. In comparison, the focus diameter of a fundamental mode laser having a wavelength of 1064 nm is about 5 m in such an arrangement. The size of the focus on the workpiece and the exact position of the beam waist relative to the observing plane of the microscope can be adjusted using telescope 12. In order to adjust the waist diameter, the magnification of the telescope must be adjustable; in order to adjust the waist position, the divergence of the beam downstream of the telescope is changed. In order to adjust the angular position of the nutating table of piezoelectrically driven nutating table 11, provision is made for a control element 14 which is designed as a joystick.

The present invention has been explained with reference to a specific embodiment. However, it is obvious that changes and modifications can be made without thereby exceeding the scope of the following claims.

List of Reference Numerals

1 microscope eyepieces

2 zoom optical system

3 dichroic mirror

4 lens

5 laser

6 telescope

7 observing beams

8 laser beam

9 workpiece

10 tiltable deflection mirror

11 nutating table

12 telescope

13 lens

14 control element

What is claimed is:

1. An optical device comprising a stereomicroscope having a lens (4, 13), and a laser (5) which emits a laser beam (8) for machining a workpiece (9),
wherein a tiltable mirror (10) is provided by means of which the laser beam (8) can be guided through the lens (4, 13) over the workpiece (9).

2. The optical device as recited in claim 1,
wherein the tiltable mirror (10) is arranged inside the stereomicroscope.

3. The optical device as recited in claim 1,
wherein the tiltable mirror (10) is arranged between the laser (5) and the stereomicroscope.

4. The optical device as recited in claim 3,
wherein a fixed deflection mirror is provided which receives the laser beam coming from the tiltable mirror (10) and deflects it to the lens (4, 13).

5. The optical device as recited in claim 1,
wherein the tiltable mirror (10) is motor-driven.

6. The optical device as recited in claim 1,
wherein the tiltable mirror (10) includes a piezoelectrically driven nutating table (11).

7. The optical device as recited in claim 1,
wherein a control element (14) is provided for adjusting the angular position of the nutating table (11).

8. The optical device as recited in claim 7,
wherein the control element (14) is a joystick.

9. The optical device as recited in claim 1,
wherein the laser beam (8) can be focused by the lens (4, 13) to a focus, the focus having a focus diameter.

10. The optical device as recited in claim 9,
wherein a telescope (6, 12) with adjustable magnification is provided which allows adjustment of the focus diameter.

11. The optical device as recited in claim 9,
wherein a telescope (6, 12) is provided which allows adjustment of the divergence of the laser beam (8).
